(19) United States
(12) Patent Application Publication
(10) Pub. No.: US 2012/0049454 A1
(43) Pub. Date: Mar. 1, 2012

(54) Non-trivia game and method of play

(76) Inventor: Douglas P. Arduini, San Ramon, CA (US)

(21) Appl. No.: 12/807,124

(22) Filed: Aug. 27, 2010

(51) Int. Cl. A63F 3/00; G09B 19/22

(52) U.S. Cl. 273/249; 434/128

(57) ABSTRACT

Typically, games are created for entertainment purposes involving trivia information or games are created for educational purposes focused on particularized subjects. Currently, there exists a need for a game that challenges players with questions from a broad range of topics useful for everyday life that are non-trivia.

### FIELD

The current specification relates generally to board games.

### BACKGROUND

The subject matter discussed in the background section should not be assumed to be prior art merely as a result of its mention in the background section. Similarly, a problem mentioned in the background section should not be assumed to have been previously recognized in the prior art. The subject matter in the background section merely represents different approaches to accomplishing various tasks.

Typically, games are created for entertainment purposes involving trivia information or games are focused on particularized subjects. Currently, there exists a need for a game that challenges players with non-trivia information from a broad range of topics that may be educational, valuable, and useful for everyday life.

### BRIEF DESCRIPTION OF THE FIGURES

In the following drawings like reference numbers and labels are used to refer to the same elements. Although the following figures depict various examples of inventions associated with this specification, the inventions associated with this specification are not limited to the examples depicted in the figures.

FIG. 1 shows a diagram of an embodiment of a playing board used for tracking the progress of players from a starting line toward a finish line.

FIG. 2 shows a diagram of an embodiment of dice used for determining the order of players and for determining the categories from which questions are drawn.

FIG. 3 shows a diagram of an embodiment of a token used for representing players on the game board during play.

FIG. 4A shows a diagram of an embodiment of a card container for storing and organizing question and answer cards for each of the question categories.

FIG. 4B shows a diagram of another embodiment of a card container for storing and organizing question and answer cards for each of the question categories.

FIG. 4C shows a diagram of another embodiment of a card container for storing and organizing question and answer cards for each of the question categories.

FIG. 5 shows a diagram of an embodiment of a question and answer card sleeve that provides for the secure viewing of questions and answers printed on the question and answer cards.

FIG. 6A shows a flowchart of an embodiment of a method of playing the non-trivia game at the slowest pace.

FIG. 6B shows a flowchart of an embodiment of a method of playing the non-trivia game at the slowest pace and at a higher difficulty.

FIG. 7A shows a flowchart of an embodiment of a method of playing the non-trivia game at the slow pace.

FIG. 7B shows a flowchart of an embodiment of a method of playing the non-trivia game at the slow pace and at a higher difficulty.

FIG. 8A shows a flowchart of an embodiment of a method of playing the non-trivia game at the fastest pace.

FIG. 8A shows a flowchart of an embodiment of a method of playing the non-trivia game at the fastest pace and at a higher difficulty.

FIGS. 9A, 9B and 9C show an embodiment of two sample question and answer card front sides and one backside from non-trivia question category one.

FIG. 10A, 10B, and 10C show an embodiment of two sample question and answer card front sides and one backside from non-trivia question category two.

FIG. 11A, 11B, and 11C show an embodiment of two sample question and answer card front sides and one backside from non-trivia question category three.

FIG. 12A, 12B, and 12C show an embodiment of two sample question and answer card front sides and one backside from non-trivia question category four.

FIG. 13A, 13B, and 13C show an embodiment of two sample question and answer card front sides and one backside from non-trivia question category five.

FIG. 14A, 14B, and 14C show an embodiment of two sample question and answer card front sides and one backside from non-trivia question category six.

FIGS. 15A and 15B show an embodiment of a set of sample instructions for playing the non-trivia game.

FIG. 16 shows a diagram of an alternative embodiment of a playing board used for tracking the progress of players from a starting line toward a finish line.

FIG. 17A, 17B, and 17C show an alternative embodiment of two sample question and answer card front sides and one backside from non-trivia question category one.

FIG. 18 shows a block diagram of a computer used for playing the non-trivia game in electronic form.

FIG. 19 shows an alternative embodiment of a sample and question and answer card front side from non-trivia question category one.

### DETAILED DESCRIPTION

Although various embodiments of the invention may have been motivated by various deficiencies with the prior art, which may be discussed or alluded to in one or more places in the specification, the embodiments of the invention do not necessarily address any of these deficiencies. In other words, different embodiments of the invention may address different deficiencies that may be discussed in the specification. Some embodiments may only partially address some deficiencies or just one deficiency that may be discussed in the specification, and some embodiments may not address any of these deficiencies.

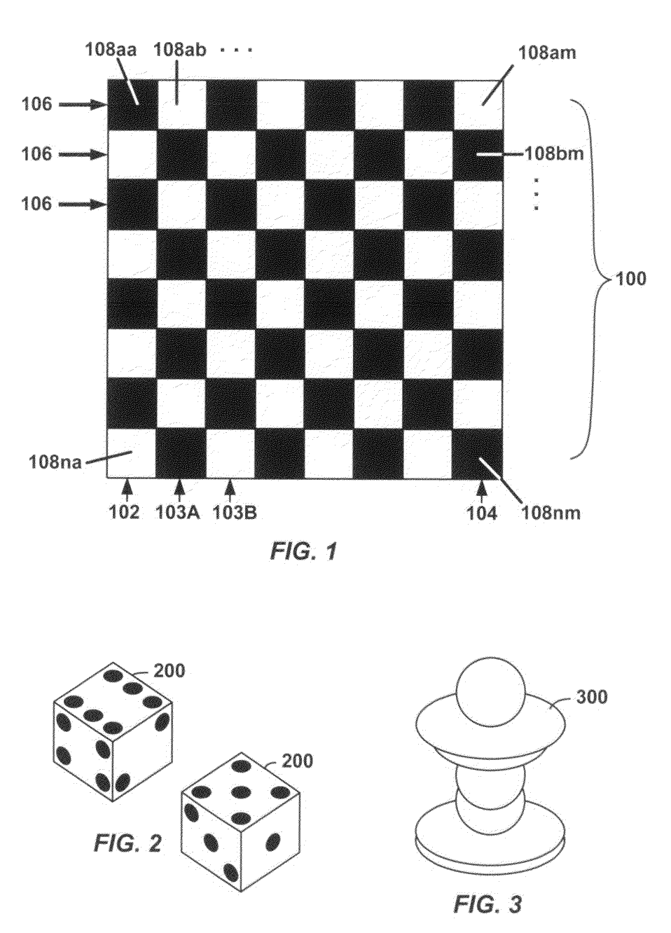

In general, at the beginning of the discussion of each of FIGS. 1-19 is a brief description of each element, which may have no more than the name of each of the elements in the particular figure that is being discussed. After the brief description of each element, each element of FIGS. 1-19 is further discussed in numerical order. In general, each of FIGS. 1-19 is discussed in numerical order, and the elements within FIGS. 1-19 are also usually discussed in numerical order to facilitate easily locating the discussion of a particular element. Nonetheless, there is not necessarily any one location where all of the information of any element of FIGS. 1-19 is located. Unique information about any particular element or any other aspect of any of FIGS. 1-19 may be found in, or implied by, any part of the specification.

In various places in discussing the drawings, a range of letters, such as a-n . . . are used to refer to individual elements of various series of elements that are the same. In each of these series, the ending letters are integer variables that can be any number. Unless indicated otherwise, the number of elements in each of these series is unrelated to the number of elements in others of these series. Specifically, even though one letter (e.g. “m”) comes earlier in the alphabet than another letter (e.g., “n”), the order of these letters in the alphabet does not mean that the earlier letter represents a smaller number. The value of the earlier letter is unrelated to the later letter, and may represent a value that is greater the same or less than the later letter.

### Game Components

FIG. 1 shows a playing board 100 used for tracking the progress of players from a starting line 102 toward a finish line 104. Playing board 100 may be composed of any number of lanes 106, each lane 106 having any number of spaces 108aa thru 108nm. Playing board 100 may also contain starting line 103A and 103B. In other embodiments, playing board 100 may not have all of the components listed and/or may have other elements instead of, or in addition to, those listed above.

The playing board 100 may contain a starting line 102 opposite a finishing line 104. The starting line 102 may be a line designated at one end of the playing board 100 where players initially begin game play. In an embodiment, the starting line 102 may be staggered, allowing some players to begin play closer to the finishing line 104. For example, children playing the game with adults may be given an advantage, the children beginning game play at starting line 103A or 103B while adults begin at starting line 102. The finishing line 104 may be a designated line used for determining when game play has been completed. The finishing line 104 may be at the opposite end of the playing board 100 from the starting line 102. Similar to the starting line 102, the finishing line 104 may be staggered to allow certain players to complete play earlier than other players. For example, the finish line for a younger player may be reached a number of spaces 108aa thru 108nm earlier than an adult player.

The playing board 100 may contain a grid pattern forming lanes 106. Each lane 106 may represent the progress of the player assigned to the lane, as the player attempts to answer questions during game play. Each lane 106 may be formed by a number of spaces 108aa thru 108nm. Each space 108aa thru 108nm may represent the advancement of players from the starting line 102, 103A, or 103B toward the finish line 104. For example, if a player correctly answers a question, his or her token may be advanced forward toward the finish line 104 a predetermined number of spaces 108aa thru 108nm depending on the pace of play chosen for the game. If a player incorrectly answers a question, his or her token may be moved back a predetermined number of spaces 108aa thru 108nm toward the starting line 102, 103A, 103B or remain stationary, depending on the pace of play chosen for the game.

In an embodiment, the playing board 100 may contain eight lanes 106, each lane 106 containing eight spaces 108aa thru 108nm between the starting line 102 and the finish line 104. In an alternative embodiment, the playing board 100 may contain more lanes 106 to accommodate a greater number of players. Additionally, the lanes 106 may contain more than eight spaces 108aa thru 108nm, extending the number of spaces 108aa thru 108nm a player would need to advance before winning the game.

In yet another embodiment, the playing board 100 may contain both more lanes 106 and spaces 108aa thru 108nm. In an embodiment, the spaces 108aa thru 108nm may be square. In an alternative embodiment, the spaces 108aa thru 108nm may be rectangular. The spaces 108aa thru 108nm may be of any random alternating colors or the spaces 108aa thru 108nm may be all uniformly colored.

In an embodiment, the playing board 100 may be made of paper, laminate, cardboard, wood, plastic, or composite, among other materials.

FIG. 2 depicts a pair of dice 200 which may be used for determining the order of players and the categories from which questions are drawn. In an embodiment, each of the die 200 may have six numbered sides, each side marked uniquely with a number one through six. In other embodiments, the dice 200 may not have all of the components listed and/or may have other elements and/or configurations instead of, or in addition to, those listed above.

For example, as shown in FIG. 2, the sides of the dice may be marked with a number of dots representing a number one through six. Alternatively, the sides of the dice may be marked with Arabic numerals. Additionally, in other embodiments, the die may have more than six sides. In other embodiments, the die may be marked with numbers beginning at numbers other than one, for example, a seven sided die marked from two through eight. In yet other embodiments, there may be a single die or more than a pair of dice 200, for example, the use of three or more die.

The dice 200 may be used for determining the playing order of the game. For example, each player may roll the dice 200 and the player with the highest total deemed the first player. In the event two or more players have identical totals, the two or more players having identical totals may roll the dice 200 again, the player with the new highest total deemed the player taking an earlier turn. Alternatively, each player may roll the dice 200 and the player with the lowest total deemed the first player. In the event two or more players have identical totals, the two or more players having identical totals may roll the dice 200 again, the player with the new lower total deemed the player taking an earlier turn. In other embodiments, a spinner, lots, straws, or another mechanism may be used for determining turn order. In an embodiment, players may take turns clockwise from the first player. In another embodiment, the players may roll only a single die, with either the highest or lowest die value representing the first player. In yet another embodiment, players may roll more than a pair of dice 200, with either the highest or lowest totals representing the first player. In an alternative embodiment, players may take turns counter-clockwise from the first player. In an embodiment, each player takes their turn according to the relative value of their die roll compared to other players (the highest roll goes first, the second highest goes second etc.)

The dice 200 may also be used for determining which question categories a player may choose a question and answer card from. For example, after determining the playing order of the game, player one rolls the dice 200 to obtain a unique number from each of the individual die. Based on the two unique numbers obtained from the pair of dice 200, the player may choose to select a question and answer card from one of the numbered question categories, one thru six, that corresponds to one of the obtained dice numbers. For example, if the dice 200 show sides two and five, the current player has the option of answering a question selected from either question category two or category five. In an embodiment, if the numbers obtained are not unique, i.e., the two numbers on the dice are the same, the player may roll the dice again until unique numbers are obtained before selecting a question category. In an alternative embodiment, the player may select a question from the single question category corresponding to the one duplicate dice number obtained. In an embodiment, the player may roll only a single die and select a question from the single question category corresponding to the single die number obtained.

FIG. 3 depicts a token 300 for representing players on the playing board 100. In other embodiments, token 300 may not have all of the components shown in FIG. 3 and/or may have other elements and/or configurations instead of, or in addition to, those shown.

In an embodiment, the token 300 may be any shape and/or color so long as the tokens allow players on the playing board to be distinguished from one another. For example, the tokens 300 may all be identically shaped except each token 300 has a unique color. Alternatively, the tokens 300 may be uniquely shaped. For example, each token 300 may be in the shape of a different animal, a unique geometric shape, or a collection of random objects such as a shoe, car, thimble, dog, etc. In an embodiment, the tokens 300 may be in the form of a peg which may be inserted into the playing board, the playing board having holes to accept the pegs and for tracking the progress of players during the game. In another embodiment, the tokens 300 may have both a unique shape and a unique color to further distinguish players on the playing board 100.

In an embodiment, at the start of the game each player participating in the game will have a representative token 300 at the starting line 102, 103A or 103B. By correctly answering a question, a player may advance their token 300 within their lane 106 toward the finishing line 104. Depending on the pace of play, incorrectly answering a question may result in a player having to move their token 300 backward a single space 108aa thru 108nm, multiple spaces 108aa thru 108nm, or remain stationary within their lane 106. In an alternative embodiment, when there may be a significant difference in skill and knowledge between the players, players may be allowed to advance their tokens 300 for a partially correct answer. For example, a younger player that partially answers a question correctly may be allowed to advance a single space 108aa thru 108nm instead of two spaces 108aa thru 108nm forward toward the finishing line 104. In yet another embodiment, correctly answering a question may result in advancing multiple spaces 108aa thru 108nm toward the finishing line 104 and incorrectly answering a question may result in advancing only a single space 108aa thru 108nm toward the finishing line 104.

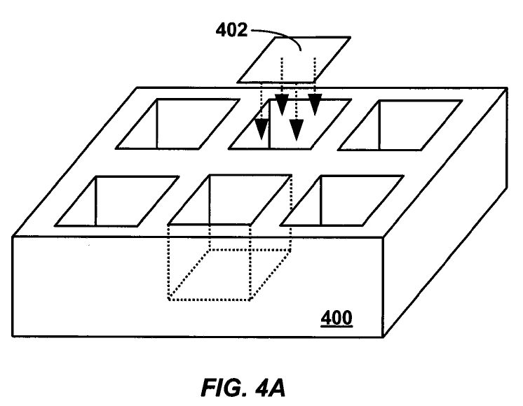

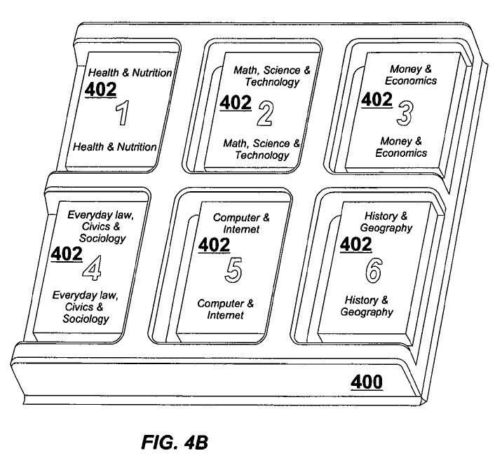

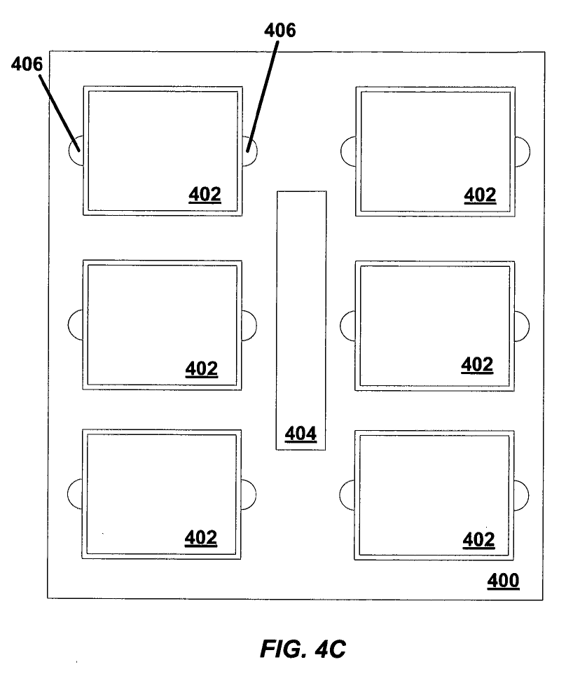

FIG. 4A depicts a card container 400 used for storing and organizing the question and answer cards 402. In other embodiments, card container 400 may not have all of the components listed and/or may have other elements instead of, or in addition to, those listed above.

In an embodiment, the card container 400 has six compartments for containing six different categories of questions. Optionally, the card container 400 may have an extra compartment for temporarily holding the question and answer cards 402 that have already been answered and/or attempted during the course of the game. The extra compartment may also be used for holding the tokens and dice when the game is stored and not in use. In an embodiment, the card container 400 may have finger wells which may allow for easier access to the question and answer cards 402. In an embodiment, the finger access wells may extend to nearly the bottom of the compartments. In another embodiment, the finger access wells may extend to the bottom of the compartments. In yet another embodiment, the finger access wells may extend any distance toward the bottom of the compartments. In an embodiment, the question and answer cards 402 are organized into six non-trivia category types. Trivia refers to knowledge that is non-essential information, particularly details about popular culture. For example, a trivia question may ask about obscure information concerning a fictional character on a television program. Non-trivia refers to information that is essential, useful, and may be educational. For example, a non-trivia question may ask about what potential impending weather conditions can be expected when presented with the information the barometric pressure has rapidly dropped (high probability of an incoming storm front). In an embodiment, non-trivia question categories may be organized into:

1. Health & Nutrition

2. Math, Science & Technology

3. Money & Economics

4. Law, Civics, & Sociology

5. Computer & Internet

6. History & Geography

In an alternative embodiment, the non-trivia categories may be organized into other different categories and/or a greater number of categories. For example, the non-trivia categories may be more detailed by dividing history questions and geography questions into their own categories. In another alternative embodiment, non-trivia categories may be organized into difficulty levels, where questions from each category may have increasing or decreasing difficulty and answering a more difficult question may allow for advancing a greater number of spaces 108aa thru 108nm toward the finishing line 104. In yet another embodiment, the questions may be organized based upon a loosely associated common thread. For example, the answers to all the questions in a category may all begin with the same letter.

While the question and answer cards 402 may be organized into six categories, the actual details of the questions may touch upon multiple categories. For example, a tax question drawn from category three may be associated with math, money and law but simply categorized into only category three. Similarly, a computer technology question may fit in both category two and category five.

The testing of a player's knowledge by attempting to correctly answer the non-trivia question and answer cards challenges players to learn information that may be educational and/or useful for everyday applications rather than for purely scholarly understanding or toward a particular course of study. For example, knowing that one should take cover under a desk or table while indoors during an earthquake is useful knowledge for everyday application (at least in areas that regularly experience earthquakes) yet, is not related to popular culture, nor geared toward scholarly understanding or any particular course of study. As another example, going to the filling station to purchase gasoline during the early morning or late evening when it is cooler results in the purchase of more gasoline at the same price is also useful knowledge for everyday application yet is not related to popular culture. While the knowledge may be subject matter covered in a physics course, questions regarding a particular subject (in this example, physics) may not be so numerous as to prepare a player with sufficient knowledge to take an exam in a course covering the subject. For example, a question may ask about the consequences of being taxed at a particular rate, which may be of great use in everyday life, yet a player would not be fully prepared to take a tax exam. In an embodiment, the subject matter covered is for entertainment purposes while being as factually accurate as possible. For example, a health and nutrition question may inquire about the signs of a heart attack. However, any medical and/or health information is for general knowledge only and is not to be taken as medical or health advice.

Each question and answer card 402 may have both a question and answer printed on the card. In an embodiment, the question and answer are printed on the same side of the card. In an alternative embodiment, the question and answer are printed on opposite sides of the card. In an embodiment, after the correct answer is an educational description of the correct answer that may be derived from single or multiple reference sources. In another embodiment, after the correct answer is an explanation of the correct answer that may be derived from single or multiple reference sources.

To prevent players from inadvertently viewing the questions and answers or gaining an unfair advantage by seeing answers prematurely, another player may read the question and answer card 402 and prompt the current player. Additionally, the question and answer cards 402 may be printed in a manner that provides for the secure viewing of the question and answer. For example, the question and answer cards 402 may be printed in such a manner that questions and answers are hidden within background markings that are of a color that make inadvertently viewing the question and answer text unlikely, and the intentional reading of the question and/or answer without the use of a color filter difficult. Alternatively, question and answer card 402 may be printed in such a manner that the question and answer are hidden within a background having a polarization that make reading the question and answer text very difficult without the use of a polarizing filter. In yet another embodiment, question and answer card 402 may be printed in any manner that makes reading the question and answer text very difficult by simply seeing the question and answer card 402 with the unaided human eye.

FIG. 4B shows a diagram of an alternative embodiment of a card container 400 for storing and organizing question and answer cards 402 for each of the question categories. The card container 400 of FIG. 4B has question card compartments with an open side, which may allow for easier access to the question and answer cards 402.

FIG. 4C shows a diagram of an alternative embodiment of a card container 400 for storing and organizing question and answer cards 402 for each of the question categories. The card container 400 of FIG. 4C may contain accessory compartment 404. Accessory compartment 404 may be used for temporarily holding the question and answer cards 402 that have already been answered and/or attempted during the course of the game. The accessory compartment 404 may also be used for holding the tokens and dice when the game is stored and not in use. The card container 400 of FIG. 4C may have card compartments with finger access wells 406, which may allow for easier access to the question and answer cards 402. In an embodiment, the finger access wells 406 may extend to nearly the bottom of the question card compartments. In another embodiment, the finger access wells may extend to the bottom of the question card compartments. In yet another embodiment, the finger access wells 406 may extend any distance toward the bottom of the question card compartments.

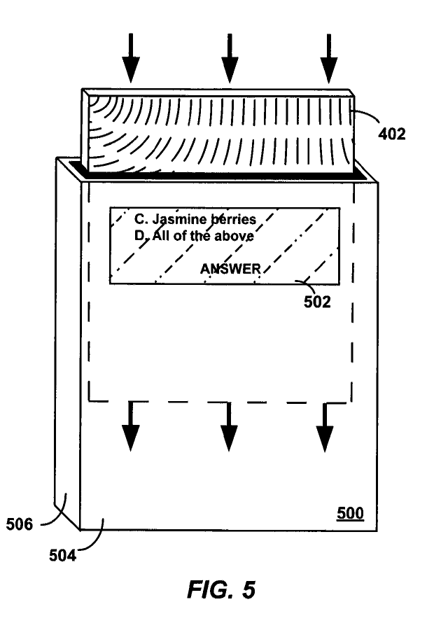

FIG. 5 shows a question and answer card sleeve 500 that provides for the secure viewing of questions and answers printed on the question and answer cards 402. Question and answer card sleeve 500 may contain a viewing window 502, front and rear walls 504, and sidewalls 506. In other embodiments, question and answer card sleeve 500 may not have all of the components listed and/or may have other elements instead of, or in addition to, those listed above.

The front and rear walls 504 and sidewalls 506 of question and answer card sleeve 500 may be made of any material that is opaque to prevent the inadvertent viewing of questions and answers or gaining an unfair advantage by seeing answers prematurely. Without the use of the question and answer card sleeve 500, attempting to view the questions and answers printed on the question and answer cards 402 may be extremely difficult while in plain sight of other players. In an alternative embodiment, the question and answer card sleeve 500 may be any material that is translucent. For example, question and answer card sleeve 500 may be of a translucent material that may be of similar color as the printed questions and/or answers, preventing the inadvertent viewing of the question and answers. Alternatively, the question card sleeve material may have a polarization that filters out the polarization of the light reflected off the questions and/or answers, so that the questions and/or answers cannot be read through the front and rear walls 504 of the question and answer card sleeve 500. The use of question and answer card sleeve 500 to read question and answer cards 402 may allow a player to prompt himself or herself with a question without inadvertently viewing the answer.

The viewing window 502 may be made of a color filtering material that allows the question and answer cards 402 to be easily read when viewed through the window. For example, the question and answer cards 402 may have a question and answer hidden within background markings that are of a particular color. The viewing window 502 may then be chosen to be made with a color filtering material that filters the same particular color printed on the question and answer card 402, leaving visible the question but the answer is hidden by the background markings of the particular color unless also viewed through the viewing window 502.

Alternatively, the viewing window 502 may be made of a polarizing filter material that allows the question and answer cards 402 to be easily read when viewed through the window. For example, the question and answer cards 402 may have a question but the answer is hidden within background markings that are polarized. Viewing window 502 may then be chosen to be made with a polarizing filter material that filters the polarized background markings on question and answer card 402, leaving visible the question but the answer is hidden by the polarized background markings unless also viewed through the viewing window 502.

### Method of Play

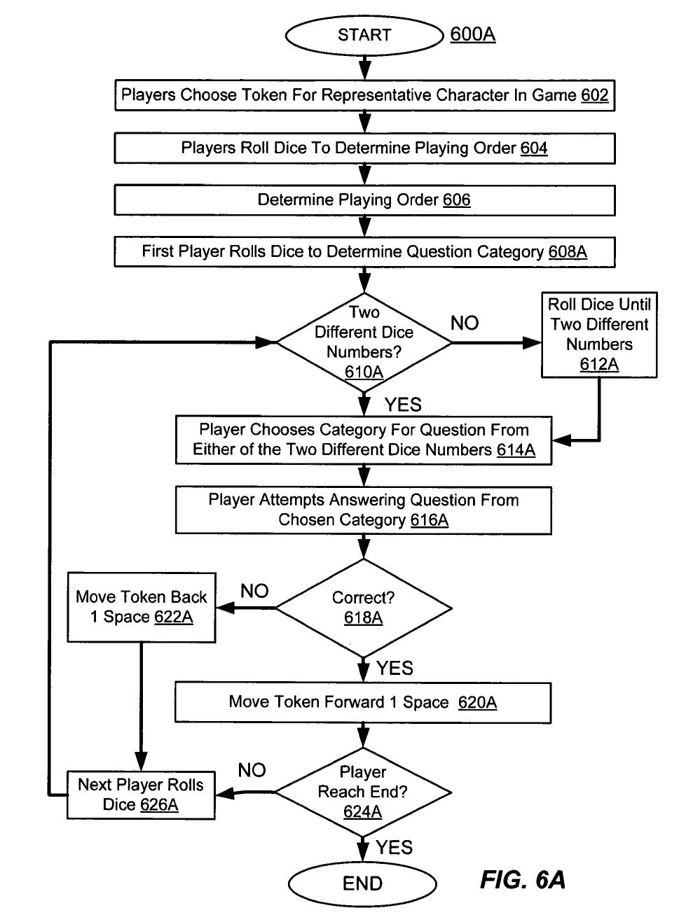

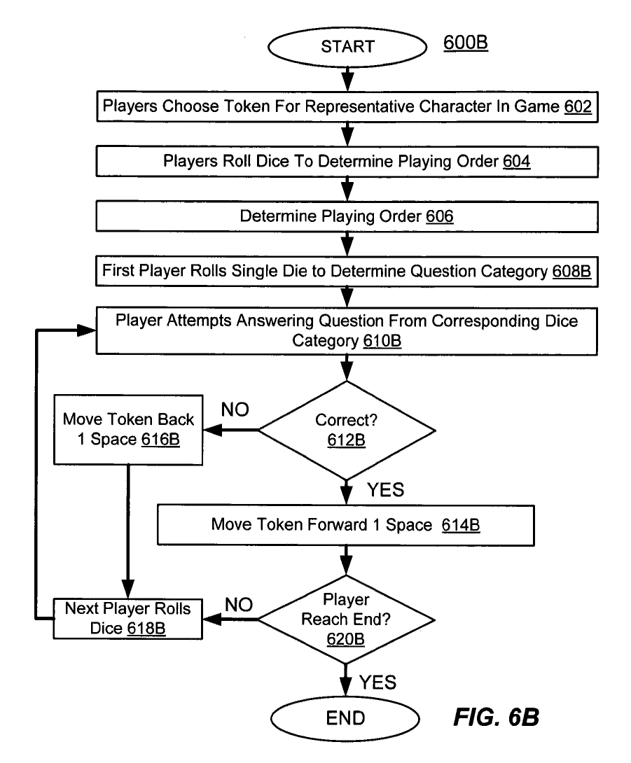

FIG. 6A shows a block diagram of a method 600A for playing the non-trivia game at the slowest pace. Method 600A is one of a number of different methods players may choose to play the non-trivia game. Choosing to play the non-trivia game at the slowest pace results in taking a greater length of time to complete the game as compared to playing the game at a slow pace (but which is not as slow as the slowest pace) or at the fastest pace. When playing the non-trivia game at the slowest pace, answering a question correctly may allow a player to advance his or her token 300 one space 108aa thru 108nm closer toward the finish line 104. However, answering a question incorrectly results in moving the token 300 back one space 108aa thru 108nm towards the starting line 102.

The method for playing the non-trivia game at the slowest pace begins in step 602 with players selecting a token 300 to represent and track their progress on the playing board 100. In step 604, each player rolls the dice 200 to individually obtain a dice total for determining the playing order. In step 606, players compare dice totals to determine the playing order. As described previously, in an embodiment, the player having the highest total may be deemed the first player with the remaining players taking turns clockwise around the table after the first player.

In step 608A, game play begins with the first player rolling the dice 200 to determine which two question categories will be available to choose a question and answer card 402 from. Upon rolling the dice, in step 610A, players determine whether the dice 200 have different numbers showing. If the dice 200 do not have different numbers showing, for example both die are showing the number five, in step 612A the player will roll the dice again until two different numbers are showing. If the dice 200 have two different numbers showing, in step 614A the rolling player chooses a category from which he or she will attempt to answer a question and answer card 402. The player to the right of the player rolling the dice may act as the reader and may draw the top question and answer card 402 from the question category chosen by the rolling player and read the question on the question and answer card 402.

In step 616A, the rolling player will attempt to answer the question on the question and answer card 402 drawn from the chosen category. In step 618A, a determination is made whether the rolling player correctly answered the question card. If the player answers the question correctly, in step 620A, the player may advance his or her token 300 one space 108 toward the finish line 104. If the rolling player answers the question incorrectly, in step 622A, the player will move his or her token 300 one space 108aa thru 108nm back toward the starting line 102, 103A, or 103B. In step 624A, a determination is made whether the rolling player has reached the finished line 104. If the rolling player has reached the finishing line 104, then the game ends, otherwise, it becomes the turn of the next player. In step 626A, the next player clockwise from the player who last rolled the dice 200 will repeat steps 608A through 626A. Players will continue to take turns rolling the dice 200 and answering questions until a player answers a question and answer card 402 correctly resulting in his or her token 300 reaching the finish line 104.

FIG. 6B shows a flowchart of an embodiment of a method 600B of playing the non-trivia game at the slowest pace at a higher difficulty. The method 600B depicted in FIG. 6B differs from the method in FIG. 6A by allowing players to roll only a single die when determining which question category from which to draw a question and answer card 402. Choosing to play according to the rules of method 600B may increase the difficulty of the non-trivia game because players may be forced to choose a question and answer card 402 from an unfamiliar question category.

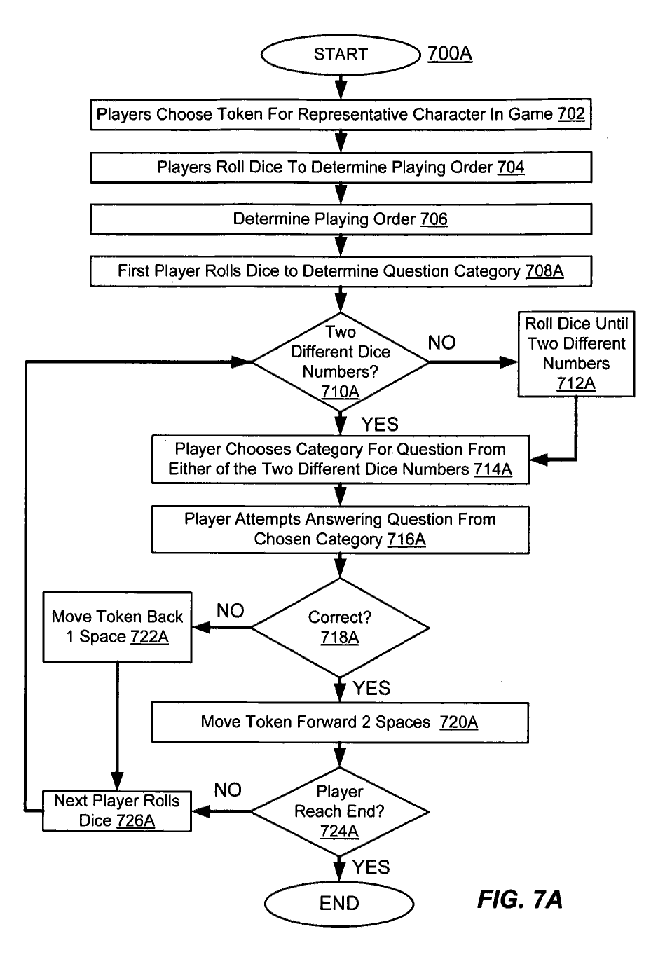

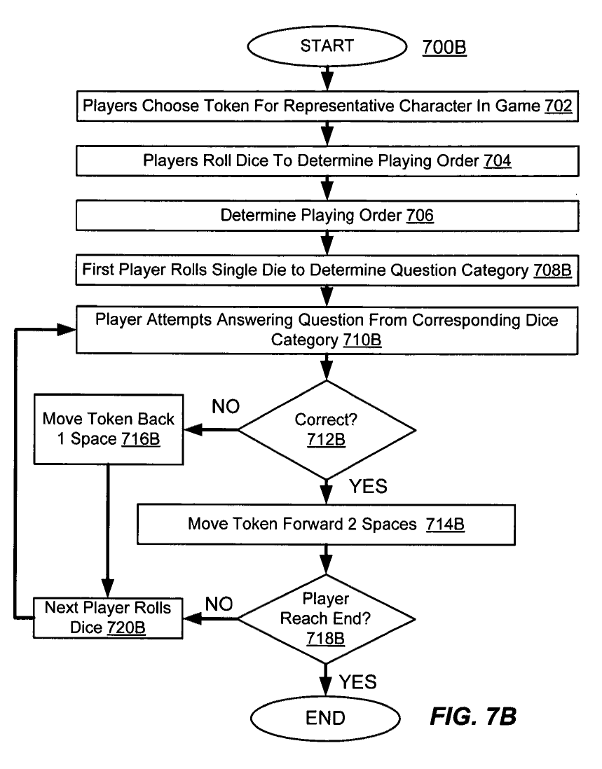

FIG. 7A shows a block diagram of a method 700A for playing the non-trivia game at the slow pace. Method 700A is one of a number of different methods players may choose to play the non-trivia game. Choosing to play the non-trivia game at the slow pace results in game play taking less time to complete compared to playing the game at the slowest pace, but more time compared to playing the game at the fastest pace. When playing the non-trivia game at the slow pace, answering a question correctly allows a player to advance his or her token 300 two spaces 108aa thru 108nm closer toward the finish line 104. However, answering a question incorrectly results in moving the token back one space 108aa thru 108nm towards the starting line 102, 103A, or 103B.

The method 700A for playing the non-trivia game at the slow pace begins with the same steps as used in the method 600A for playing the game at the slowest pace. Steps 702-718A are the same as steps 602-618A. However, in contrast to method 600A, after attempting to answer the question in step 718A, if the player answers the question correctly, in step 720A, the player may advance his or her token 300 two spaces 108aa thru 108nm toward the finish line 104. If the rolling player answers the question incorrectly, in step 722A, the player will move his or her token 300 one space 108aa thru 108nm back toward the starting line 102, 103A or 103B. If the rolling player has reached the finishing line 104 then the game ends, otherwise, it becomes the turn of the next player. In step 726A, the next player clockwise from the player who last rolled the dice 200 will repeat steps 708A through 726A. Players will continue to take turns rolling the dice 200 and answering questions until a player answers a question and answer card 402 correctly resulting in his or her token 300 reaching the finish line 104.

FIG. 7B shows a flowchart of an embodiment of a method 700B of playing the non-trivia game at the slow pace at a higher difficulty. The method 700B depicted in FIG. 7B differs from method 700A by allowing players to roll only a single die when determining which question category from which to draw a question and answer card 402. Choosing to play according to the rules of method 700B may increase the difficulty of the non-trivia game because players may be forced to choose a question and answer card 402 from an unfamiliar question category.

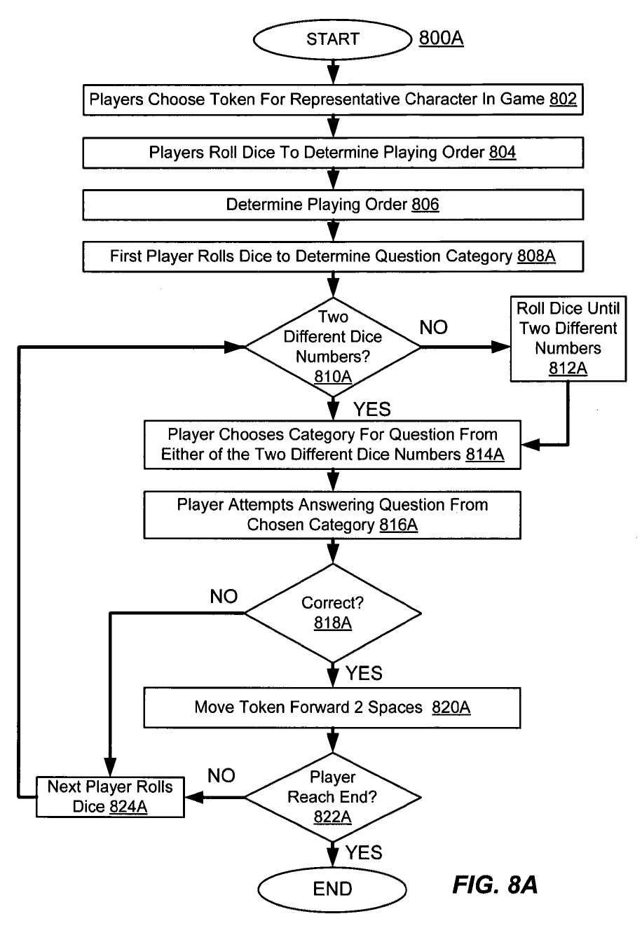

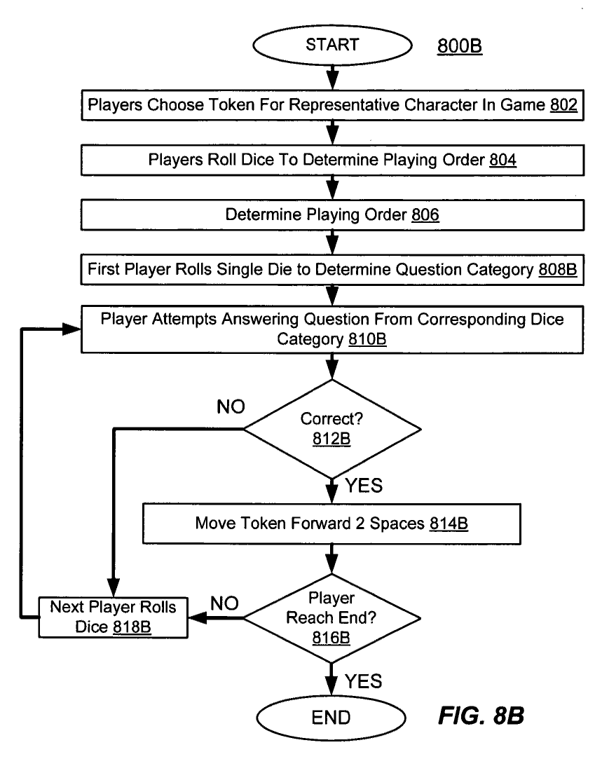

FIG. 8A shows a block diagram of a method 800A for playing the non-trivia game at the fastest pace. Method 800A is one of a number of different methods players may choose to play the non-trivia game. Choosing to play the non-trivia game at the fastest pace results in game play taking less time to complete as compared to playing the game at a slow pace or at the slowest pace. When playing the non-trivia game at the fastest pace, answering a question correctly allows a player to advance his or her token 300 two spaces 108aa thru 108nm closer toward the finish line 104. Answering a question incorrectly results in the token remaining stationary.

The method 800A for playing the non-trivia game at the fastest pace begins with the same steps as used in methods 600A and 700A for playing the game. Steps 802-818A are the same as steps 702-718A and 602-618A. However, in contrast to methods 600A and 700A, after attempting to answer the question in step 818A, if the player answers the question correctly, in step 820A, the player may advance his or her token 300 two spaces 108 toward the finish line 104. If the rolling player answers the question incorrectly, the player may leave his or her token 300 stationary. If the rolling player has reached the finishing line 104 then the game ends, otherwise, it becomes the turn of the next player. In step 824A, the next player clockwise from the player who last rolled the dice will repeat steps 808A through 824A. Players will continue to take turns rolling the dice 200 and answering questions until a player answers a question and answer card 402 correctly resulting in his or her token reaching the finish line 104.

FIG. 8B shows a flowchart of an embodiment of a method of playing the non-trivia game at the fastest pace at a higher difficulty. The method 800B depicted in FIG. 8B differs from the method 800A of FIG. 8A by allowing players to roll only a single die when determining which question category from which to draw a question and answer card 402. Choosing to play according to the rules of method 800B may increase the difficulty of the non-trivia game because players may be forced to choose a question and answer card 402 from an unfamiliar question category.

### Sample Question Cards

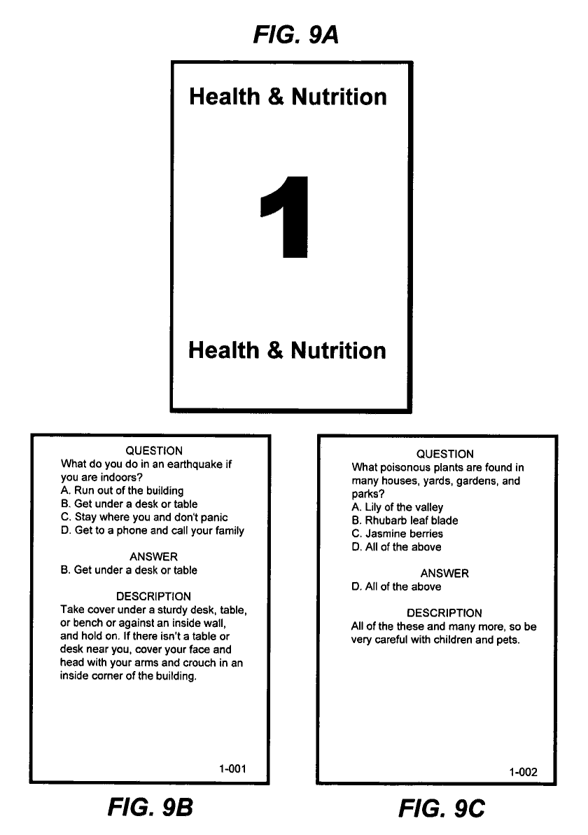

FIGS. 9A, 9B, and 9C shows a diagram of an embodiment of two sample question and answer card front sides and one backside from non-trivia question category one. Non-trivia question category one may contain questions about health and nutrition, as represented by the sample question and answer cards 402 in FIG. 9. In the lower corner of question and answer card front sides there may be identification for indicating the category of the question and answer card and the question number of the particular question and answer card. For example, FIG. 9B indicates the question and answer card 402 is question one from question category one. FIG. 9C indicates the question and answer card 402 is question number two from question category one.

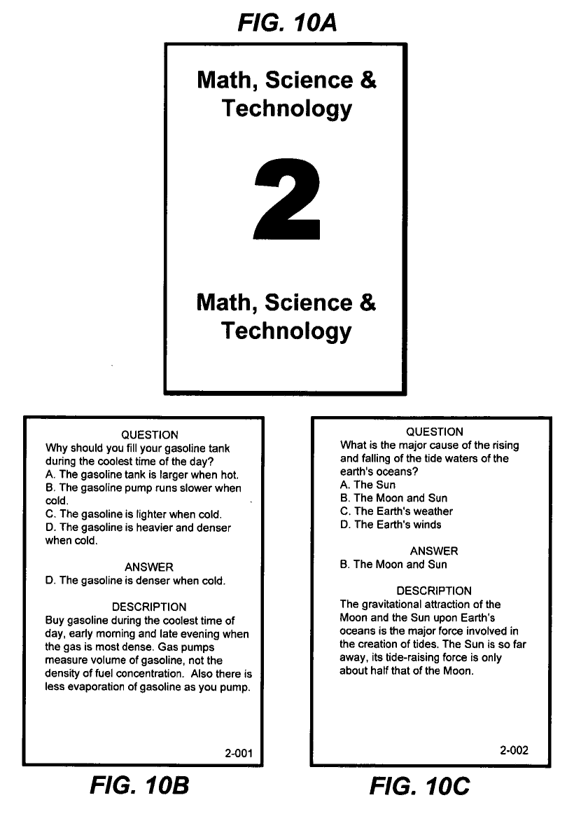

FIG. 10A, 10B, and 10C shows a diagram of an embodiment of two sample question and answer card front sides and one backside from non-trivia question category two. Non-trivia question category two may contain questions about math, science, and technology, as represented by the sample question and answer cards 402 in FIG. 10.

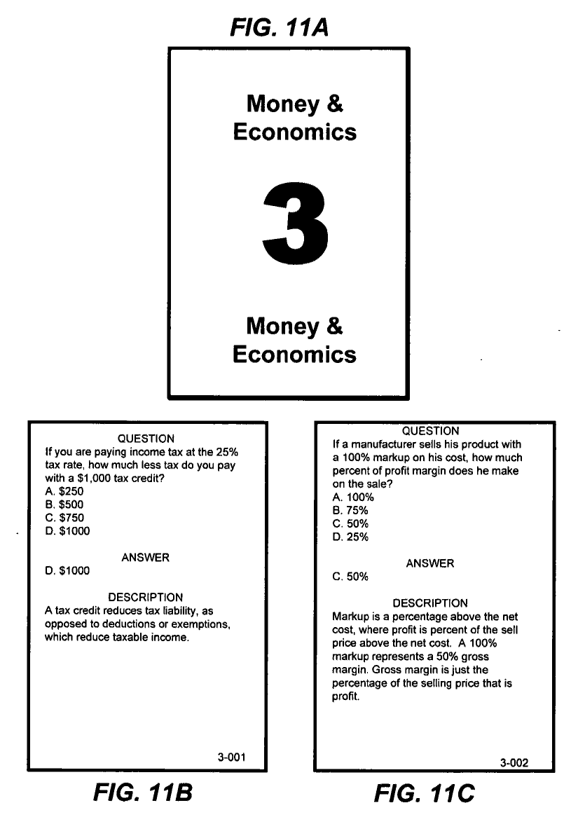

FIG. 11A, 11B, and 11C shows a diagram of an embodiment of two sample question and answer card front sides and one backside from non-trivia question category three. Non-trivia question category three may contain questions about money and economics, as represented by the sample question and answer cards 402 in FIG. 11.

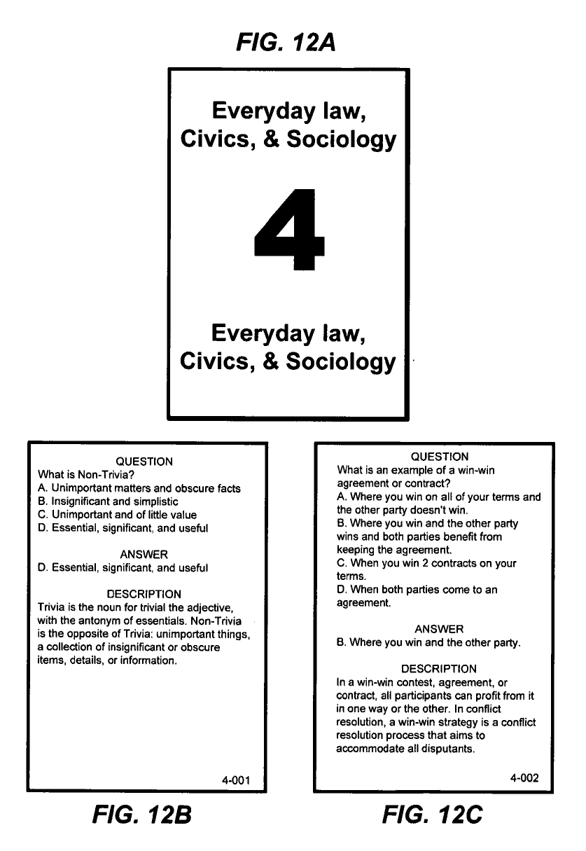

FIG. 12A, 12B, and 12C shows a diagram of an embodiment of two sample question and answer card front sides and one backside from non-trivia question category four. Non-trivia question category four may contain questions about law, civics, and sociology, as represented by the sample question and answer cards 402 in FIG. 12.

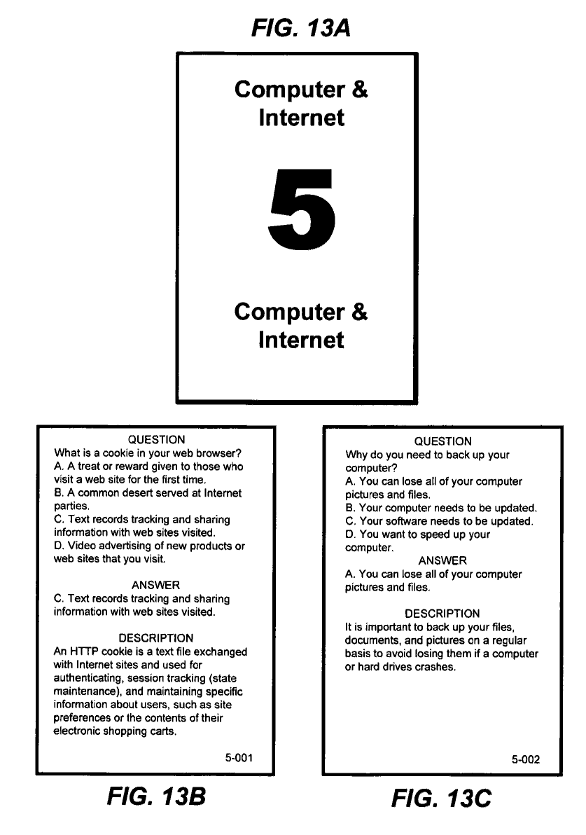

FIG. 13A, 13B, and 13C shows a diagram of an embodiment of two sample question and answer card front sides and one backside from non-trivia question category five. Non-trivia question category five may contain questions about computers and the internet, as represented by the sample question and answer cards 402 in FIG. 13.

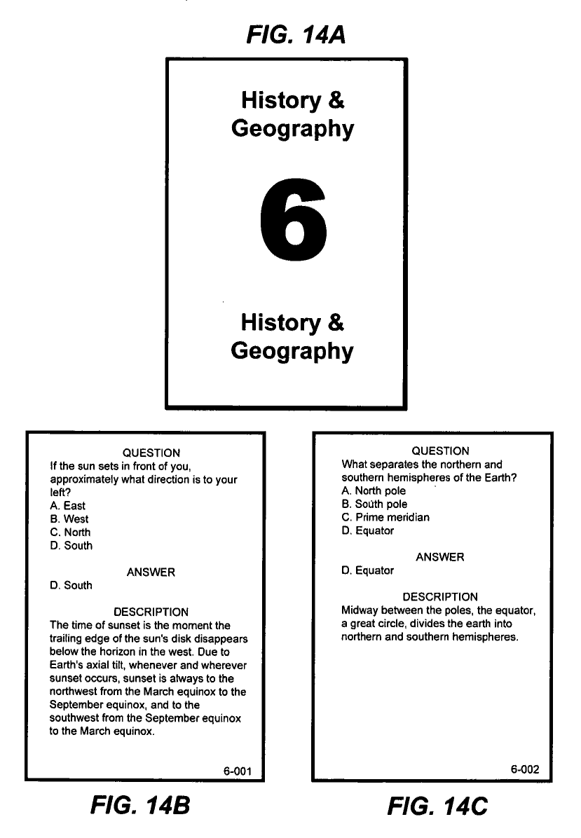

FIG. 14A, 14B, and 14C shows a diagram of an embodiment of two sample question and answer card front sides and one backside from non-trivia question category six. Non-trivia question category six may contain questions about history and geography, as represented by the sample question and answer cards 402 in FIG. 14.

### INSTRUCTIONS AND OTHER EMBODIMENTS

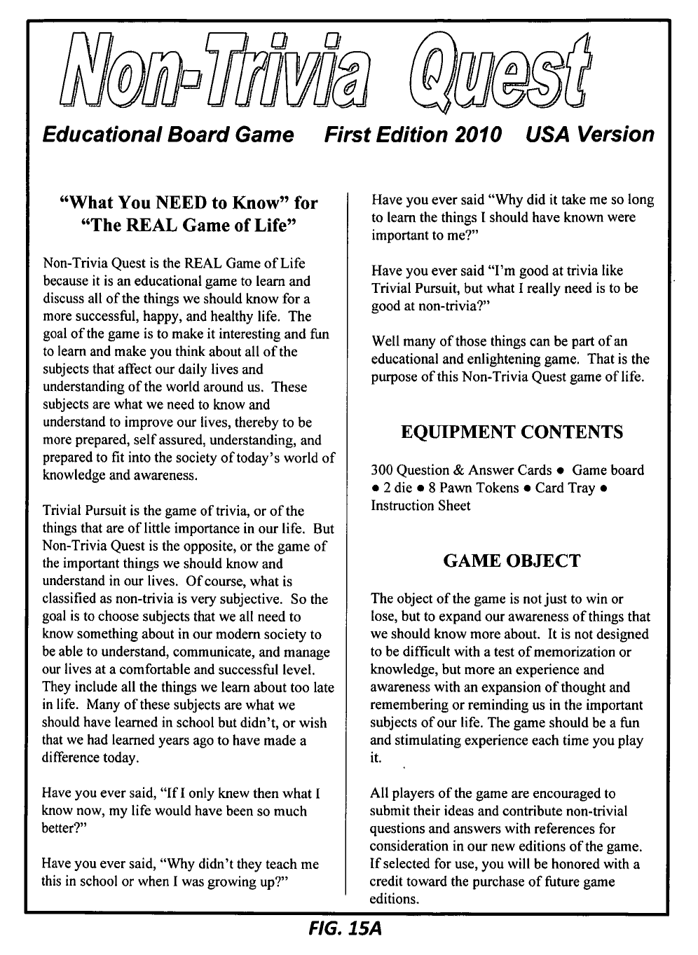

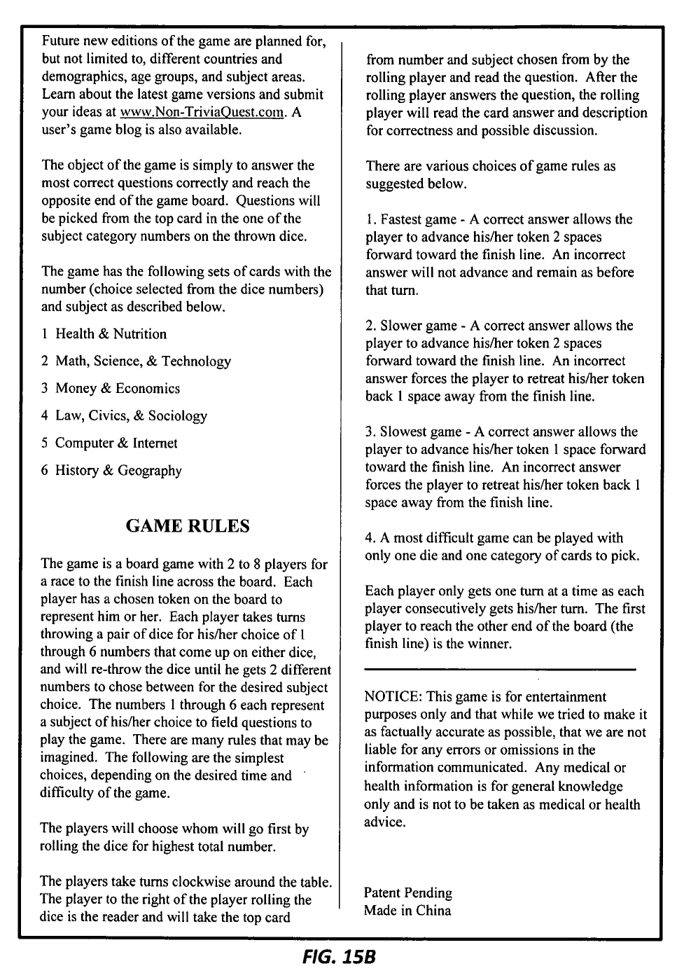

FIGS. 15A and 15B show an embodiment of a set of sample instructions for playing the non-trivia game. The instructions, rules, and methods for playing the non-trivia game at the fastest, slow, and slowest paces with different difficulties may be contained and described in an included set of human readable media. The human readable media may be in any format that may be read and comprehended by a person. For example, as shown in FIGS. 15A and 15B, the human readable media may be in the form of instructions printed on paper (e.g., on a single sheet of booklet). In other embodiments, the instructions may be printed on cardboard (e.g., on the box cover or an instructions card), or plastic, among other materials. The instructions may be printed on a single sheet, a booklet, the inside or outside of a box cover, or an instructions card. The human readable media may also be in the form of a text or document stored electronically on a computer readable media that may be read on a computer. For example, the rules and methods may be stored on a compact disc (e.g., read only memory (CD-ROM)), included with the game, or stored on a computer readable medium stored on a server, available for reading over a network. Alternatively, the rules and methods may be available for download from a website maintained by the game manufacturer.

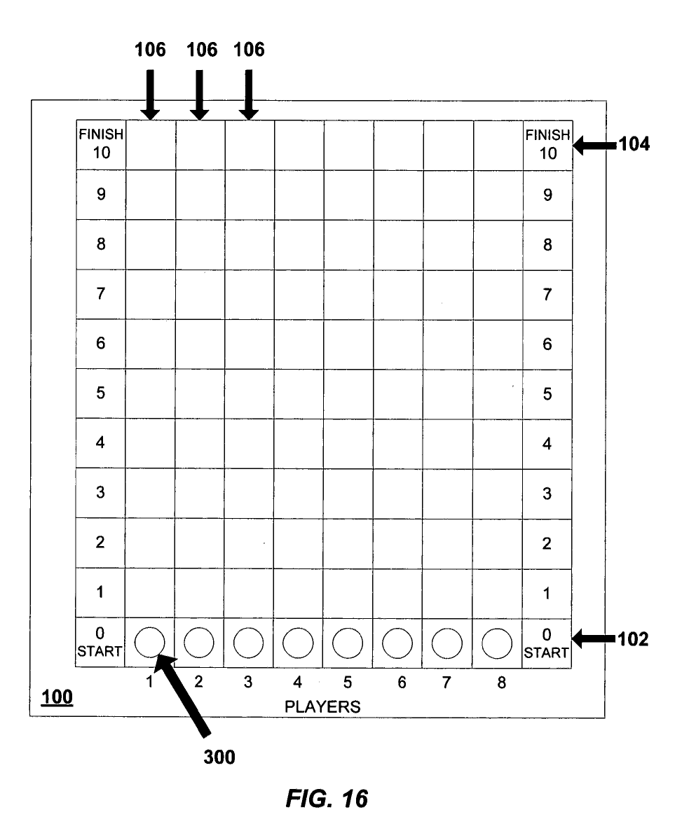

FIG. 16 shows a diagram of an alternative embodiment of a playing board 100 used for tracking the progress of players from a starting line toward a finish line. The playing board 100 of FIG. 16 has an indicated start and finish line printed on the board. Additionally, the playing board of FIG. 16 also has numbers printed along each outer playing lane to allow players to better track their progress through the game. FIG. 16 also depicts a full complement of player tokens 300 at the starting line. Similar to the playing board 100 of FIG. 1, the playing board 100 of FIG. 16 may contain more lanes to accommodate additional players. In an embodiment, playing board 100 may contain additional spaces to between the starting line and finish line.

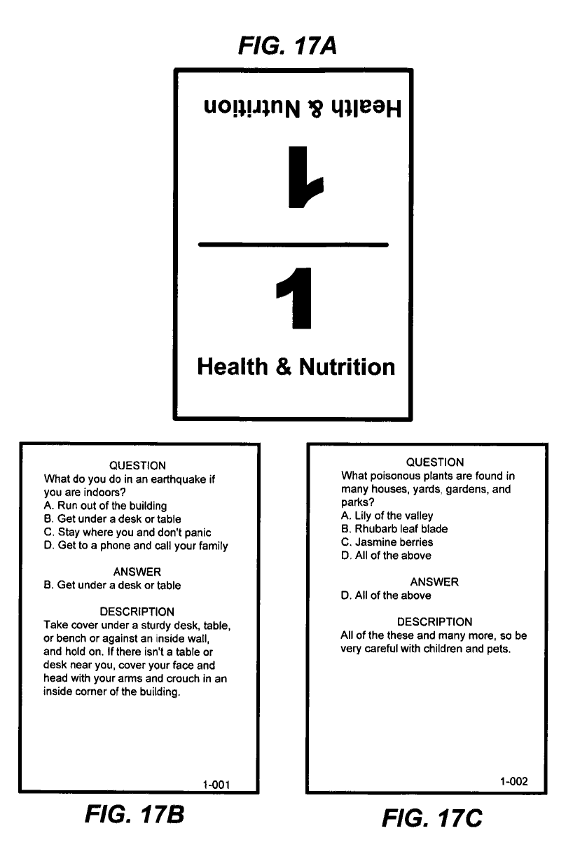

FIG. 17 shows a diagram of an alternative embodiment of two sample question and answer card front sides and one backside from non-trivia question category one. The sample backside of FIG. 17 differs from the sample backside of FIG. 9 by having a category number and category description printed on each question and answer card such that players seated across from each other at a table may both read the question and answer card.

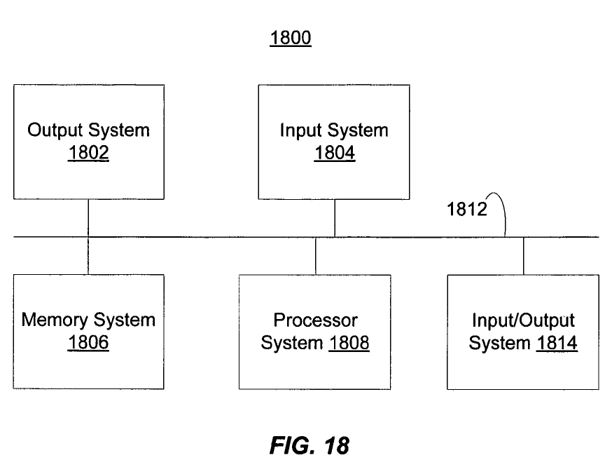

FIG. 18 shows a block diagram of a computing device 1800 used for playing the non-trivia game in an electronic form. The computing device may include output system 1802, input system 1804, memory system 1806, processor system 1808, communications system 1812, and input/output device 1814. In other embodiments, computing device 1800 may not have all of the components listed and/or may have other elements instead of, or in addition to, those listed above.

In an embodiment, the computing device 1800 may be a desktop computer. In another embodiment, the computing device 1800 may be a portable laptop or netbook computer. In yet another embodiment, the computing device 1800 may be a smartphone, a PDA, a gaming console, or a portable gaming system, among other things. In an embodiment, more than one computing device 1800 may be used in a client-server arrangement that may allow players to connect remotely and play the electronic version of the non-trivia game over a network, intranet, and/or wirelessly. In an embodiment, the electronic version of the non-trivia game may be implemented in an Internet environment, with players using a web-browsing program on a computing device 1800 to play the electronic version of the non-trivia game

Output system 1802 may include any one of, some of, any combination of, or all of a monitor system, a handheld display system, a printer system, a speaker system, a connection or interface system to a sound system, an interface system to peripheral devices and/or a connection and/or interface system to a computer system, intranet, and/or internet, for playing the electronic version of the non-trivia game.

Input system 1804 may include any one of, some of, any combination of, or all of a keyboard system, a mouse system, a track ball system, a track pad system, buttons on a handheld system, a scanner system, a microphone system, a connection to a sound system, and/or a connection and/or interface system to a computer system, intranet, and/or internet (e.g., IrDA, USB), for playing an electronic version of the non-trivia game.

Memory system 1806 may include, for example, any one of, some of, any combination of, or all of a long term storage system, such as a hard drive; a short term storage system, such as random access memory; a removable storage system, such as a floppy drive or a removable drive; and/or flash memory. Memory system 1806 may include one or more machine readable mediums that may store a variety of different types of information. The term machine-readable medium is used to refer to any medium capable of carrying information that is readable by a machine. One example of a machine-readable medium is a computer-readable medium.

Memory system 1806 may contain a set of instructions or software, which when processed by the processor system 1808, may cause the computing device 1800 to display and execute an electronic version of the non-trivia game. In an embodiment, players may use the input system 1804 and output system 1802 of computer 1800 to play the electronic version of the non-trivia game.

Processor system 1808 may include any one of, some of, any combination of, or all of multiple parallel processors, a single processor, a system of processors having one or more central processors and/or one or more specialized processors dedicated to specific tasks for playing an electronic version of the non-trivia game. Also, processor system 1808 may include one or more Digital Signal Processors (DSPs) in addition to or in place of one or more Central Processing Units (CPUs) and/or may have one or more digital signal processing programs that run on one or more CPU.

Communications system 1812 communicatively links output system 1802, input system 1804, memory system 1806, processor system 1808, and/or input/output system 1814 to each other. Communications system 1812 may include any one of, some of, any combination of, or all of electrical cables, fiber optic cables, and/or means of sending signals through air or water (e.g. wireless communications), or the like. Some examples of means of sending signals through air and/or water include systems for transmitting electromagnetic waves such as infrared and/or radio waves and/or systems for sending sound waves.

Input/output system 1814 may include devices that have the dual function as input and output devices for playing the electronic version of the non-trivia game. For example, input/output system 1814 may include one or more touch sensitive screens, which display images for the non-trivia game and therefore are an output device and accept input, such as answer selection, when the screens are pressed by a finger or stylus, for example. The touch sensitive screens may be sensitive to heat and/or pressure. One or more of the input/output devices may be sensitive to a voltage or current produced by a stylus, for example. Input/output system 1814 is optional, and may be used in addition to or in place of output system 1802 and/or input device 1804.

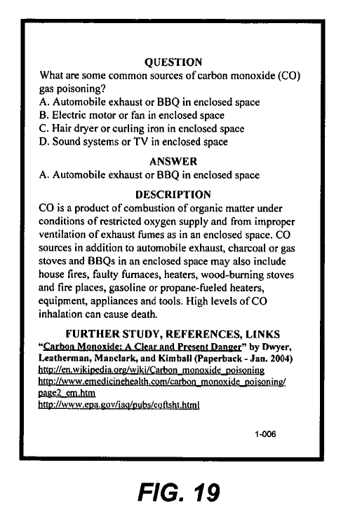

FIG. 19 shows an alternative embodiment of a sample question and answer card front side from non-trivia question category one. The sample front side of FIG. 19 differs from the sample front side of FIG. 9 and FIG. 17 by having a lower portion of the question and answer card front side contain further sources of information about the answer. For example, in an embodiment, the lower portion of the question and answer card front side may have a section for further study, references, and/or links. The section for further study, references, and/or links may contain bibliographical information for books, references, and/or Internet links containing detailed information about the answer. In an electronic embodiment of the non-trivia game, the bibliographical information for books, references, and/or Internet links may be in hypertext transfer protocol format and may allow the player to be taken directly to the detailed information and/or an online vendor where the reference may be purchased.

Although the invention has been described with reference to specific embodiments, it will be understood by those skilled in the art that various changes may be made and equivalents may be substituted for elements thereof without departing from the true spirit and scope of the invention. In addition, modifications may be made without departing from the essential teachings of the invention.

1. A method comprising:
determining a player to take a current turn;
determining a category of a question to be asked of the player;
drawing a card from the category, the card having at least one question that tests the player's knowledge of a subject that is useful for life; and
if the player answers correctly, advancing a token on a playing board, the questions not being focused around any particular course of study or job training.

2. The method of claim 1, the category being chosen from a given number of categories, each category corresponding to at least one side of a die, the determining of which category including at least
the player rolling at least one die; and
the player choosing a category that corresponds to a face up side of one of the die rolled.

3. The method of claim 1, the playing board having at least one lane for each player, the advancing of the token moves the token closer to a finish point and further from a start point.

4. The method of claim 1, further comprising moving the token on the playing board away from a finish point, if the answer was wrong.

5. The method of claim 1, further comprising the player that went last reading the question on the card to the current player.

6. The method of claim 1, the card having the question on a side of the card where the answer is located.

7. The method of claim 6, further comprising a player placing a card in a sleeve, the sleeve having a window, and the question being readable only when in the window thereby allowing the player to read his own question without seeing his answer.

8. The method of claim 7, the card having an answer hidden within background markings of a color different than that of the answer, and the window of the sleeve having a color filter filtering the background color so that the answer can be read.

9. The method of claim 7, the card having an answer hidden within background markings of a polarization different than that of the answer and the window of the sleeve having a polarization filter filtering the polarization of the background markings so that the answer can be read.

10. A game comprising:
a set of cards, each card having at least one question and answer about information that is useful in life, the set of questions on the card are not predominantly about one course of study or one job;
the set of cards having at least one subset of cards for each of a plurality of categories;
a pair of dice for determining a category;
a playing board having a plurality of lanes for tokens; and
a plurality of tokens, including at least one token for each lane.

11. The game of claim 10 further comprising a sleeve for placing a card, the sleeve having a window for viewing content.

12. The game of claim 11, the set of cards having answers hidden within background markings of a color different from the answer, the window having a color filter filtering out the background markings.

13. The game of claim 11, the set of cards having answers hidden within background markings of a polarization different from the answer, the window having a polarization filter filtering out the background markings.

14. The game of claim 10 further comprising a sheet for carrying playing instructions, which include a selectable choice of instructions to advance a token of a user that answers a question correctly.

15. The game of claim 10 further comprising a set of playing instructions contained on human readable media, where the instructions include:
determining a player to take a current turn;
determining a category of a question to be asked of the player;
drawing a card from the category, the card having at least one question that tests the player's knowledge of a subject that is useful for life; and
if the player answers correctly, advancing a token on a playing board, the questions not being focused around any particular course of study or job training.

16. The game of claim 10, the set of cards being marked on at least one side with at least category information, the category information having at least two different regions, the regions having opposite orientations from one another.

17. The game of claim 10, each card having at least a detailed description of the answer.

18. The game of claim 10 further comprising a card container having at least compartments and finger wells, the finger wells being located on opposite sides of the compartments.

19. The game of claim 10, the playing board having an indicated start line opposite, and parallel to, an indicated finish line, the start line having labels for each of the lanes for tokens, and progress labels marking at least an outer border outside of an outer lane; the progress labels mark progress of tokens moving from the start line to the finish line.

20. A machine-readable medium storing thereon one or more instructions, which when implemented cause a processor to implement an electronic game comprising:
a simulated set of cards for display on a screen, each simulated card having at least one question and answer about information that is useful in life, the set of questions on the simulated card are not predominantly about one course of study or one job;
the simulated set of cards having at least one subset of simulated cards for each of a plurality of categories;
a simulated pair of dice for display on a screen, for determining a category;
a simulated playing board for display on a screen, having a simulated plurality of lanes for tokens; and
a simulated plurality of tokens for display on a screen, including at least one simulated token for each lane.

21. The machine readable medium of claim 20, wherein the simulated cards have at least one source of information about the at least one answer.

22. A machine readable medium having one or more machine instructions, which when invoked cause a machine-implemented method to be performed, the method comprising:
determining a player to take a current turn, via a machine including at least a processor system having one or more processors and memory system having at least a computer readable medium;
determining, by the processor system, a category of a question to be asked of the player, each category being stored on the computer readable medium;
drawing, by the machine, a computer simulation of a card from the category, the card having at least one question that tests the player's knowledge of a subject that is useful for life, the simulated card and the question being stored in the memory system; and
if the machine receives an answer on behalf of the player that answers the question correctly, the machine simulating an advancing of a simulation of a token on a simulation of a playing board, the questions stored in the memory system not being focused around any particular course of study or job training.

23. A method of playing a game comprising:
determining a category, via a pair of dice;
selecting a card from a set of cards, each card having at least one question and answer about information that is useful in life, the set of questions on the card are not predominantly about one course of study or one job, the set of cards having at least one subset of cards for each of a plurality of categories, the selecting of the card including selecting a card from the category determined by the pair of dice; and
if the question is answered correctly, advancing a token on a playing board having a plurality of lanes for tokens, the token being one of a plurality of tokens, including at least one token for each lane.

24. A game comprising:
dice for determining a category;
a set of cards, each card having at least one question and answer about information that is useful in life, the set of questions on the card are not predominantly about one course of study or one job, the set of cards having at least one subset of cards for each of a plurality of categories, the category determined by the dice being one of the set of categories from which a card is selected; and
a playing board having a plurality of lanes; and
a plurality of tokens for advancing on the playing board if the question is answered correctly, including at least one token for each lane and player, plurality of tokens including one token that is advanced if player having the token answers the question correctly.
